(19) United States
(12) Patent Application Publication
(10) Pub. No.: US 2014/0358332 A1
(43) Pub. Date: Dec. 4, 2014

(54) METHODS AND SYSTEMS FOR CONTROLLING AN AIRCRAFT

(71) Applicant: Gulfstream Aerospace Corporation, Savannah, GA (US)

(72) Inventors: Simón Octavio Colmenares, Savannah, GA (US); Ed Wischmeyer, Savannah, GA (US)

(21) Appl. No.: 13/908,154

(22) Filed: Jun. 3, 2013

(51) Int. Cl. B64C 19/00

(52) U.S. Cl. CPC B64C 19/00
USPC 701/3

(57) ABSTRACT

Methods, aircraft, and instrumentation systems are provided. An aircraft instrumentation system includes a first sensor and a controller. The first sensor is configured to detect a first gesture within a first task envelope located in an aircraft. The controller is coupled with the first sensor and is configured to compare the first gesture with a plurality of stored gestures and generate an aircraft related task in response to a match between the first gesture and a stored gesture of the plurality of the stored gestures.

### TECHNICAL FIELD

The technical field relates generally to aircraft instrumentation and control, and more particularly relates to aircraft instrumentation with three dimensional gesturing sensors.

### BACKGROUND

As modern aviation advances, the demand for ever-increasing flight envelopes and pilot performance grows. To help meet this demand on the aircraft and on the pilots, modern aircraft include impressive arrays of displays, instruments, and sensors designed to provide the pilot with menus, data, and graphical options intended to enhance pilot performance and overall safety of the aircraft and the passengers.

A typical aircraft cockpit includes a cursor control device that employs knobs and buttons to control the displays. The device is often implemented on a column or device shaped like a handle and located on armrests for the pilots. While these cursor control devices in current aircraft are adequate, there is room for improvement. Furthermore, by virtue of current cursor control devices being mounted to specific columns or handlebars, a pilot's personal preference regarding his or her preferred control hand cannot be honored.

Another cockpit configuration employs touch sensing displays that have embedded touch sensors. These touch sensing displays are often heavy and expensive. Accordingly, the cost and weight of the aircraft increase when these touch sensing displays are utilized.

Accordingly, it is desirable to provide an instrumentation system with increased ease of use and decreased cost and weight. Furthermore, other desirable features and characteristics of the present invention will become apparent from the subsequent detailed description of the invention and the appended claims, taken in conjunction with the accompanying drawings and this background of the invention.

### SUMMARY OF EMBODIMENTS

Various non-limiting embodiments of a method, an aircraft, and an aircraft instrumentation system are disclosed herein.

In a first non-limiting embodiment, the aircraft instrumentation system includes, but is not limited to, a first sensor and a controller. The first sensor is configured to detect a first gesture within a first task envelope located in an aircraft. The controller is coupled with the first sensor and is configured to compare the first gesture with a plurality of stored gestures and generate an aircraft related task in response to a match between the first gesture and a stored gesture of the plurality of the stored gestures.

In a second non-limiting embodiment, the method includes, but is not limited to, monitoring a first sensor that is configured to detect a first gesture within a first task envelope located in the aircraft, comparing the first gesture with a plurality of stored gestures using a controller, generating an aircraft related task in response to a match between the first gesture and a stored gesture of the plurality of stored gestures.

In a third non-limiting embodiment, the aircraft includes, but is not limited to, a first sensor and a controller. The first sensor is configured to detect a first gesture within a first task envelope located in the aircraft. The controller is communicatively coupled with the first sensor and is configured to compare the first gesture with a plurality of stored gestures and generate an aircraft related task in response to a match between the gesture and a stored gesture of the plurality of stored gestures.

### BRIEF DESCRIPTION OF THE DRAWINGS

Advantages of the present invention will be readily appreciated, as the same becomes better understood by reference to the following detailed description when considered in connection with the accompanying drawings wherein:

FIG. 1 is a simplified block diagram of an instrumentation system for an aircraft in accordance with some embodiments;

FIG. 2 is a simplified side view of a cockpit in an aircraft that includes the instrumentation system of FIG. 1 in accordance with some embodiments; and

FIG. 3 is a flow diagram of a method for operating an aircraft in accordance with some embodiments.

### DETAILED DESCRIPTION

The following detailed description is merely exemplary in nature and is not intended to limit application and uses. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the disclosed embodiments and not to limit the scope of the disclosure which is defined by the claims. Furthermore, there is no intention to be bound by any expressed or implied theory presented in the preceding technical field, background, brief summary, the following detailed description or for any particular computer system.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below, in one embodiment, as being “connected,” in alternative embodiments similar elements may be “coupled,” and vice versa. Thus, although the block diagrams shown herein depict example arrangements of elements, additional intervening elements, devices, features, or components may be present in an actual embodiment.

Finally, for the sake of brevity, conventional techniques and components related to computer systems and other functional aspects of a computer system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the disclosure.

In some embodiments as disclosed herein, an aircraft includes several sensors configured to detect a gesture in three dimensions, as will be described below. The sensors create a three-dimensional task envelope in a volume proximate the sensors in which to detect the gestures. For example, the volume for the task envelope may be located in a cockpit or a cabin of the aircraft. The sensors are configured to detect specific arm/hand/finger movements (gestures) and provide an output to a controller. The controller interprets the output of the sensors and generates cursor control commands for the avionics systems.

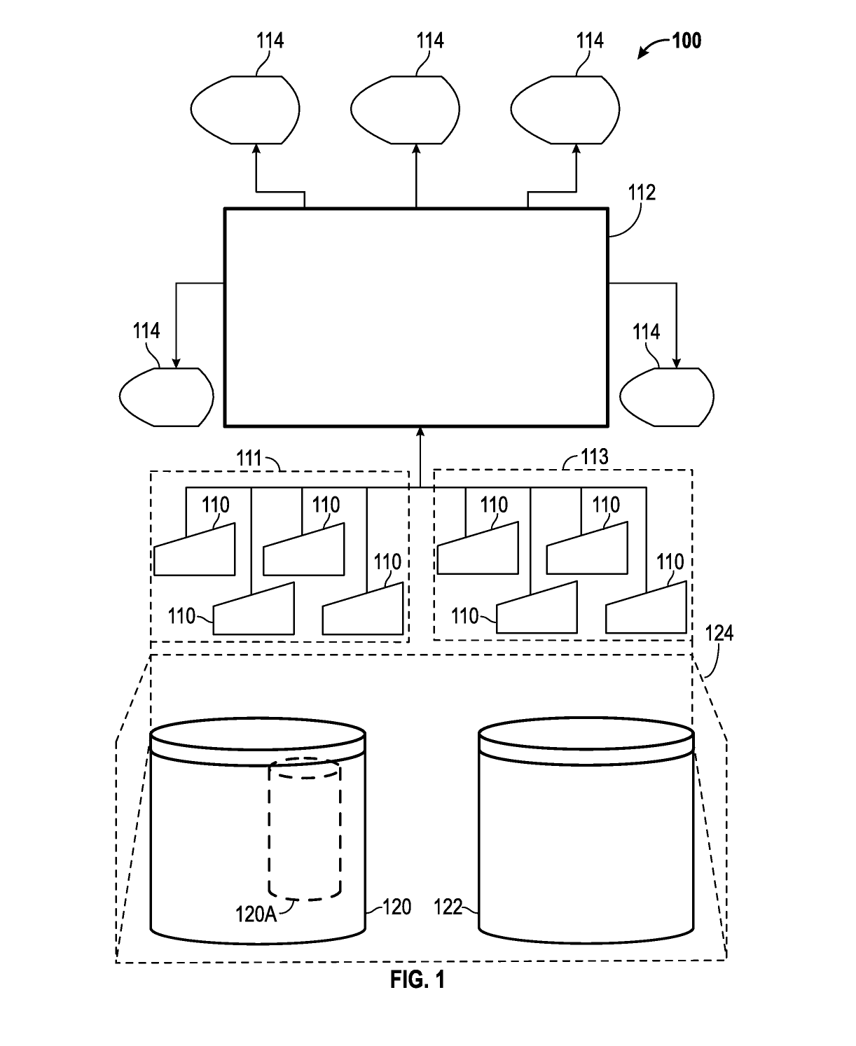

Referring now to FIG. 1, an example of an instrumentation system 100 for an aircraft is illustrated in accordance with some embodiments. The instrumentation system 100 includes a plurality of sensors 110, a controller 112, and at least one display 114. In the illustrated embodiment, sensors 110 and display 114 are each communicatively coupled with controller 112. Such communicative coupling may be achieved by any suitable method, including, but not limited to, either or both wired coupling and wireless coupling. In some embodiments, a single sensor 110 and/or multiple controllers 112 are utilized.

The sensors 110 are configured to detect movement and gesturing within a first task envelope 120 and a second task envelope 122. In the example provided, the task envelopes 120, 122 are subsets of a volume 124 in which the sensors 110 are able to detect movement. The first task envelope 120 is a three dimensional space that surrounds a seat of a pilot in the aircraft. The second task envelope 122 is a three dimensional space that surrounds a seat of a co-pilot in the aircraft. Accordingly, movement and gestures by the pilot or the co-pilot may be detected by the sensors 110 and analyzed by the controller 112.

The task envelopes 120, 122 may be any suitable shape or size and each at least partially overlaps an expected area of movement of the pilot and the copilot, respectively. In some embodiments, the task envelopes 120, 122 may surround other crew members of the aircraft or may be configured to have adjustable size and location based on a current location of a crew member. For example, the task envelope may be configured based on the pilot preferences even when the pilot is seated in the copilot seat. In some embodiments, the pilot may move about the cabin with the task envelope 120 following the pilot. In some embodiments, the pilot or copilot may adjust the size and location of the task envelopes 120, 122 to detect gestures by a particular arm or hand of the pilot or copilot while disregarding gestures by the other arm or hand of the pilot or copilot. For example, an adjusted task envelope 120A illustrates an adjusted task envelope 120 both in size and location relative to the first task envelope 120.

In the example illustrated, movement within the first task envelope 120 is detected with a first group 111 of four sensors 110 and movement within the second task envelope 122 is detected with a second group 113 of four sensors 110. It should be appreciated that in other embodiments, a greater number of sensors or a smaller number of sensors may be utilized to detect gestures and movement within the task envelopes 120, 122 without departing from the scope of the present disclosure.

The sensors 110 may be mounted to a ceiling of the aircraft, to an instrument panel in the cockpit, to an inside wall of the aircraft, or any other suitable location to provide three dimensional sensing within the task envelopes 120, 122. In some embodiments, the sensors are mounted so that the volume 124 and the task envelopes are entirely collocated to detect movement only within the task envelopes 120, 122. In some embodiments, the sensors 110 are mounted to detect movement within an entire interior volume of the aircraft. When detection over the entire interior volume is utilized, the controller 112 may be configured to filter out movements or commands based on a set of rules. The rules may define a set volume, such as the task envelopes 120, 122, or may define volumes relative to variables such as the locations of authorized crew members within the aircraft. In some embodiments, the rules may define what stored gestures are recognized by a particular person based on authentication of the person, such as by facial recognition techniques.

The sensors 110 may incorporate any suitable technology, such as optical, ultrasound, infrared, and capacitive technologies. In some embodiments, the sensors 110 are ultrasonic touchless sensors that transmit signals and detect reflections or echoes that bounce off of objects with micro-electro-mechanical microphones. Providing multiple ultrasonic sensors reduces obstruction of far objects by objects closer to any given sensor. Ultrasonic sensors advantageously provide accurate gesture detection over a large volume with low power consumption.

In some embodiments, the sensors 110 may include a camera, depth sensor, and multi-array microphone. For example, the sensors 110 may be KINECT sensors available from Microsoft. In some embodiments, the sensors 110 are two dimensional optical cameras, and the controller 112 is configured to determine the third dimension of the gestures.

The controller 112 receives signals generated by the sensors 110 and generates tasks related to operating the aircraft based on gestures within the task envelopes 120, 122, as will be described below. The controller may include any combination of software and hardware. For example, the controller may include an application specific integrated circuit (ASIC), an electronic circuit, a processor (shared, dedicated, or group) and memory that execute one or more software or firmware programs, a combinational logic circuit, and/or other suitable components that provide the described functionality.

The gestures may include any gesture involving movement of body parts (e.g., arms, legs, feet, heads, hands, fingers), movement of held objects, or movement of objects worn by a user (e.g., an armband, watch, bracelet, ring, etc). For example, the pilot may raise or lower an arm, open or close a hand, or point and bend a finger to move a cursor displayed on the displays 114 or select objects located under the cursor. Similarly, the gestures may be directly associated with particular tasks that are generated without use of the cursor. In some embodiments, the controller 112 may only generate tasks based on gestures in which the pilot is holding a control object to reduce unintended control of the displays and aircraft. In other embodiments, the controller 112 does not generate tasks until a specific gesture indicates that gesture control is desired.

The controllers may compare the detected motion with a gesture library associated with the controller 112. In some embodiments, each pilot may customize the gestures that are associated with tasks within the task envelope associated with each pilot. For example, one pilot may customize the gestures to increase a size of a displayed map when the pilot separates two fingers, while a different pilot may increase a size of the displayed map with an open palm moving away from the display 114. It should be appreciated that the actual gestures incorporated may be different from the examples described herein without departing from the scope of the present disclosure.

In some embodiments, the controller 112 generates tasks only when two unique gestures are recognized within a specified amount of time. For example, control of landing gear or other components of the aircraft may require confirmation gestures from the pilot or the co-pilot. A confirmation gesture may be unique to the task requested or may be generic to all tasks. In some embodiments, a complex confirmation gesture is required to generate tasks related to flight components and a simple confirmation gesture is required to generate tasks related to display formats.

In some embodiments, the generated tasks include altering image formats on the displays 114 and manipulating flight equipment in the aircraft. Examples of altering the image formats include changing the size of displayed content, the location of displayed content on the displays 114, and navigating through menus. For example, when the controller detects a specific gesture by the pilot, the controller 112 may generate a task to increase the size of a map presented on the display 114. Other gestures may be incorporated based on the desired manipulation of displayed content. The displays may therefore be customized and controlled in an intuitive and simple manner.

Manipulating flight equipment may include complex gestures requiring multiple arms or multiple pilots. The complexity of the gesture may be based on which flight component is to be manipulated. For example, complex gestures may be used to manipulate flaps, ailerons, landing gear, or the throttle. It should be appreciated that any additional or alternative tasks associated with conventional cursor control devices may be generated by the controller 112 based on the signals generated by the sensors 110 without departing from the scope of the present disclosure.

The display 114 may be any type of display, such as a projection screen, an illuminated gauge, an LED readout, a Head Up Display, projection, or an LCD monitor. In some embodiments, the display 114 is an optical surface that does not include sensing capability. For example, separate gesture sensing may permit utilization of a less expensive and lighter weight alternative to conventional touch screens monitors that have embedded touch sensors. Furthermore, lighter weight and less cluttered aircraft cockpits may be designed when compared with designs that incorporate knob and button based center consoles.

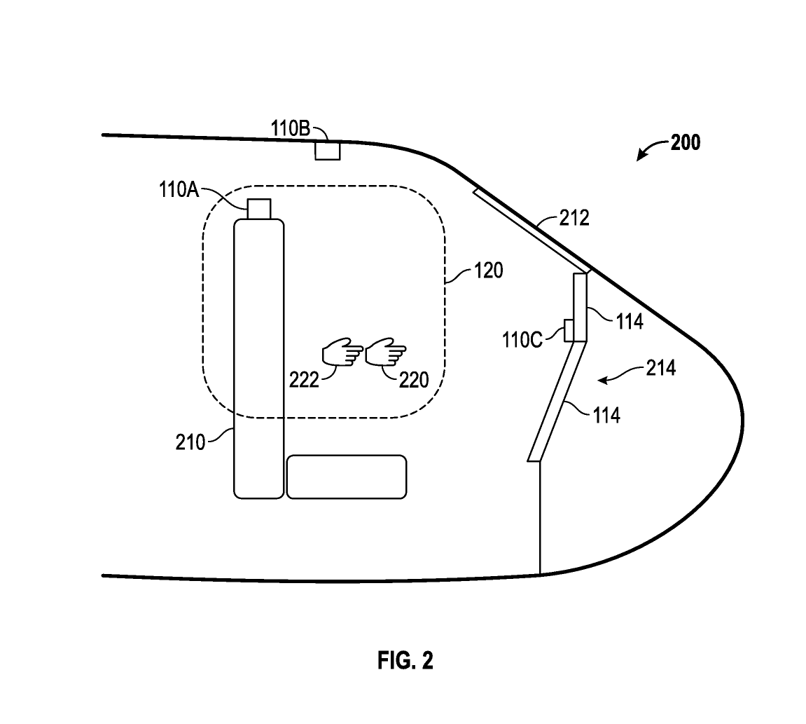

Referring now to FIG. 2, a side view of a cockpit of an aircraft 200 is illustrated in accordance with some embodiments. The aircraft 200 includes a seat 210, a windshield 212, an instrument panel 214, and various components of the instrumentation system 100, where like numbers refer to like components. The seat 210 supports a pilot who faces the windshield 212 and the display 114.

An example of a first object 220 and a second object 222 are illustrated in the task envelope 120. The objects 220, 222 may be hands, arms, control objects, pencils, or any other suitable object. Movement of the objects 220, 222 in any direction within the task envelope is detected by at least one of the sensors and analyzed by the controller, as discussed above.

A first sensor 110A is mounted to the seat 210 facing the display 114 and the windshield 212. A second sensor 110B is mounted to the ceiling of the aircraft facing downwards towards the seat 210. A third sensor 110C is mounted to the instrument panel adjacent to the displays 114 and facing the seat 210. The sensors 110A-C are configured to detect three dimensions of gestures or movements within the first task envelope 120. The three sensors 110A-C each independently detect movements within the task envelope 120. In some embodiments, a sensor is mounted to a floor surface to detect foot and/or leg movements of the pilot.

In some embodiments, the sensors 110A-C provide sensing over separate portions of the task envelope 120. In some embodiments the sensors 110A-C each provide sensing over the entire volume of the task envelope for redundancy and reduction of sensor obstruction. Such sensor redundancy may be incorporated to increase safety, availability, and reliability of the sensing capabilities of the instrumentation system 100. For example, as illustrated, the first object 220 is obstructing sensor readings of the second object 222 by the third sensor 110C. The first and second sensors 110A-B are not obstructed by the first object 220, and may be used to detect the movement of the second object 222.

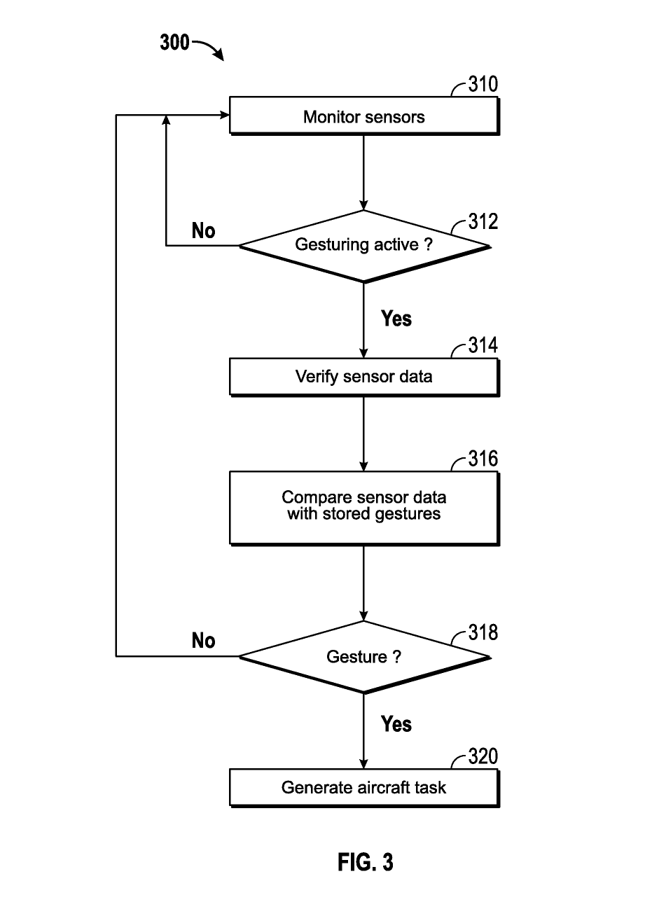

Referring now to FIG. 3, a flow diagram of a method 300 for operating an aircraft is illustrated in accordance with some embodiments. In operation 310, a controller monitors sensors mounted in a cockpit of an aircraft. For example, the controller 112 may monitor the sensors 110A-C mounted to the seat 210, the ceiling, and the instrument panel 214 of the aircraft 200.

The controller determines whether gesturing control is active in operation 312. For example, the controller 112 may disregard movements until an activation device (e.g., a button, switch, touchscreen press, etc.) is actuated or an activation gesture is performed. In some embodiments, the controller turns off or reduces power to the sensors 110 to conserve energy. When gesture control is not active, the controller continues to monitor the sensors until gesture control is active.

When gesture control is active, the controller verifies the sensor data in operation 314. In some embodiments, the controller verifies the sensor data by comparing data obtained from two separate sensors for consistency. In some embodiments, verification is omitted.

The controller compares the sensor data with stored gestures in operation 316. For example, the controller 112 may compare data from the sensors 110 with a database or library of gestures associated with the controller 112. When the sensor data does not indicate a gesture, the controller continues monitoring the sensors.

When the sensor data indicates a gesture, the controller generates an aircraft task in operation 320. The generated tasks may further relate to any task associated with a traditional cursor control device in an aircraft. As discussed above, the aircraft task may be related to control of the displays 114 or manipulation of flight equipment.

The embodiments provided herein provide numerous advantages over prior systems. For example, navigation through display menus on displays may be performed even when current handlebar cursor control devices are eliminated from a cockpit. The embodiments provided are also independent of the avionics technology and display configuration.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An aircraft instrumentation system comprising:
a first sensor configured to detect a first gesture within a first task envelope located in an aircraft; and
a controller communicatively coupled with the first sensor, the controller configured to:
compare the first gesture with a plurality of stored gestures; and
generate an aircraft related task in response to a match between the first gesture and a stored gesture of the plurality of the stored gestures.

2. The aircraft instrumentation system of claim 1, wherein the first task envelope is proximate a seat in the aircraft.

3. The aircraft instrumentation system of claim 1, further comprising a second sensor configured to detect a second gesture within a second task envelope.

4. The aircraft instrumentation system of claim 3, wherein the second task envelope is proximate a second seat in the aircraft.

5. The aircraft instrumentation system of claim 1, wherein the first sensor is one of an optical sensor, an ultrasound sensor, an infrared sensor, and a capacitive sensor.

6. The aircraft instrumentation system of claim 1, wherein the first sensor is configured to be mounted to an internal surface within a cockpit of the aircraft.

7. The aircraft instrumentation system of claim 1, wherein the controller is further configured to generate a task that commands operation of an aircraft flight component.

8. The aircraft instrumentation system of claim 1, further comprising a flight display configured to display an image, and wherein the controller is further configured to generate a task that manipulates the image to change at least one of an image format, an image size, an image location, and a menu presentation.

9. The aircraft instrumentation system of claim 1, further including a flight display configured to display an image and a cursor, and wherein the controller is further configured to generate a task that moves the cursor across the image.

10. The aircraft instrumentation system of claim 1, wherein the controller is further configured to adjust a size and location of the first task envelope based on a current location of a crew member of the aircraft.

11. The aircraft instrumentation system of claim 1, wherein the controller is further configured to filter out the stored gesture based on a set of rules.

12. The aircraft instrumentation system of claim 1, wherein the controller is further configured to generate tasks only when the stored gesture includes use of a control object to reduce unintended control of the displays and aircraft.

13. The aircraft instrumentation system of claim 1, wherein the controller is further configured to customize the plurality of gestures that are associated with tasks within the task envelope associated with particular crew member.

14. The aircraft instrumentation system of claim 1, wherein the controller is further configured to generate the aircraft related task based on a confirmation gesture detected after the first gesture.

15. The aircraft instrumentation system of claim 1, wherein a complexity of the stored gesture is based on a type of the generated aircraft related task.

16. The aircraft instrumentation system of claim 1, wherein the controller generates the aircraft related task only after gesture control is activated by at least one of an activation device and a match between the stored gesture and an activation gesture.

17. A method for controlling an aircraft, the method comprising:
monitoring a first sensor that is configured to detect a first gesture within a first task envelope located in the aircraft;
comparing the first gesture with a plurality of stored gestures using a controller;
generating an aircraft related task in response to a match between the first gesture and a stored gesture of the plurality of stored gestures.

18. The method of claim 17, further comprising monitoring a second sensor that is configured to detect a second gesture within a second task envelope located in the aircraft.

19. An aircraft comprising:
a first sensor configured to detect a first gesture within a first task envelope located in the aircraft; and
a controller communicatively coupled with the first sensor, the controller configured to:
compare the first gesture with a plurality of stored gestures; and
generate an aircraft related task in response to a match between the gesture and a stored gesture of the plurality of stored gestures.

20. The aircraft of claim 9, further comprising a first seat, a second seat, and a second sensor configured to detect a second gesture within a second task envelope proximate the second seat, and wherein the first task envelope is proximate the first seat.
